(19) United States
(12) Patent Application Publication
(10) Pub. No.: US 2008/0045252 A1
(43) Pub. Date: Feb. 21, 2008

(54) METHOD FOR DISPLAYING BACKGROUND PICTURE OF SMS MESSAGE IN TERMINAL INCLUDING SMS FUNCTION AND TERMINAL THEREOF

(75) Inventors: Jong-Hoon HAN, Suwon-si (KR); Hyun-Sup YUN, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/842,782

(22) Filed: Aug. 21, 2007

(30) Foreign Application Priority Data
Aug. 21, 2006 (KR) 2006-79035

(51) Int. Cl. H04Q 7/20; H04M 1/02

(52) U.S. Cl. 455/466; 455/566

(57) ABSTRACT

Disclosed are a method for displaying a background picture of a Short Message Service (SMS) message and a terminal thereof. The method includes extracting a telephone number of a sender of the SMS message from the received SMS message and checking whether the extracted telephone number of the sender is listed in the telephone directory when the received SMS message is requested to be output; checking whether a unique background picture has been set to correspond to the extracted telephone number of the sender if the extracted telephone number of the sender is listed in the telephone directory; and displaying the contents of the received SMS messages in the set background picture if a unique background picture has been set to correspond to the extracted telephone number of the sender.

### PRIORITY

This application claims priority under 35 U.S.C. §119(a) to an application entitled “Method Of Displaying Background Picture Of SMS Message In Terminal Including SMS Function And Terminal Thereof” filed in the Korean Industrial Property Office on Aug. 21, 2006 and assigned Serial No. 2006-79035, the contents of which is incorporated herein by reference.

### BACKGROUND OF THE INVENTION

1. Field of the Invention

The present invention relates to a method for displaying a Short Message Service (SMS) message in a terminal including an SMS function and a terminal thereof, and more particularly to a method for displaying a background picture of the SMS message and a terminal thereof.

2. Description of the Related Art

Recently, as the number of people who carry personal mobile communication terminals increases, mobile communication terminal users tend to require additional functions such as an electronic note, Internet access, etc., in addition to simple voice communication. Accordingly, the current mobile communication terminal includes various additional functions to satisfy user requirements. Especially, transmitting and receiving SMS messages among the various functions that the mobile communication terminal can perform. An operation of transmitting SMS messages or pictures received from another party is another function that allows a user to communicate with the other party in addition to a phone call. Also, the SMS message described above has an advantage in that it can transfer the user's opinion by using the SMS message without a phone call to each of other parties when a number of other parties who want to communicate is more than two. Accordingly, a function to transfer an SMS message to the other party is now employed as one of the important functions for users of mobile communication terminals.

When output of a currently received SMS message is requested, i.e., when an SMS message is displayed, a single background picture which a user has designated or a background picture which has been set by default when a terminal is manufactured is used as a background picture of the received SMS message.

When there is a request for output of a currently received SMS message, a uniformly designated background picture is applied to all of the SMS messages. Therefore, an application of one background picture to all of the SMS messages increases the user's desire to apply various background pictures to the SMS message, who want to differentiate their terminal.

### SUMMARY OF THE INVENTION

Accordingly, the present invention has been made to solve the above-mentioned problems occurring in conventional systems, and the present invention provides a method for applying various background pictures to SMS messages and a terminal thereof when the SMS messages are displayed in the terminal including an SMS function.

Also, the present invention provides a method for enabling the contents of the SMS messages to be displayed in the background pictures designated according to senders and a terminal thereof when the SMS messages are displayed in the terminal including an SMS function.

In accordance with an aspect of the present invention, there is provided a terminal for including a Short Message Service (SMS) function and displaying a background picture of SMS messages, the terminal including a key input unit for outputting a key input data corresponding to a key pressed by a user; a memory unit for storing a telephone directory, which includes at least one telephone number, one or more background pictures and received SMS messages; and a controller for extracting a telephone number of a sender of the SMS message from the received SMS message when the received SMS message is requested to be output, checking whether a unique background picture has been set to correspond to the extracted telephone number of the sender if the extracted telephone number of the sender is listed in the telephone directory, and displaying the contents of the received SMS messages in the set background picture if a unique background picture has been set to correspond to the extracted telephone number of the sender.

In accordance with another aspect of the present invention, there is provided a method for displaying an SMS message background picture in the terminal including an SMS function, the method including extracting a telephone number of a sender of the SMS message from the received SMS message, and checking whether the extracted telephone number of the sender is listed in the telephone directory when the received SMS message is requested to be output; checking whether a unique background picture has been set to correspond to the extracted telephone number of the sender if the extracted telephone number of the sender is listed in the telephone directory; and displaying the contents of the received SMS messages in the set background picture if a unique background picture has been set to correspond to the extracted telephone number of the sender.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a terminal to which an embodiment of the present invention is applied, wherein the terminal includes an SMS function;

FIG. 2 is a flow chart of a procedure of displaying a background picture of an SMS message set based on senders when the SMS messages are displayed;

FIG. 3 is a flow chart of a procedure of setting a background picture based on an individual or a group according to an embodiment of the present invention;

FIG. 4 is an example of a screen illustrating a group edit window to be displayed when a background picture based on a group is set according to an embodiment of the present invention; and

FIG. 5 is an example of a screen illustrating that the contents of the SMS message are displayed in the background picture which a user has set according to an embodiment of the present invention.

### DETAILED DESCRIPTION OF THE PREFERRED EMBODIMENTS

Hereinafter, exemplary embodiments of the present invention are described with reference to the accompanying drawings. In the following description of the present invention, the detailed description of known functions and configurations incorporated herein is omitted to avoid making the subject matter of the present invention unclear.

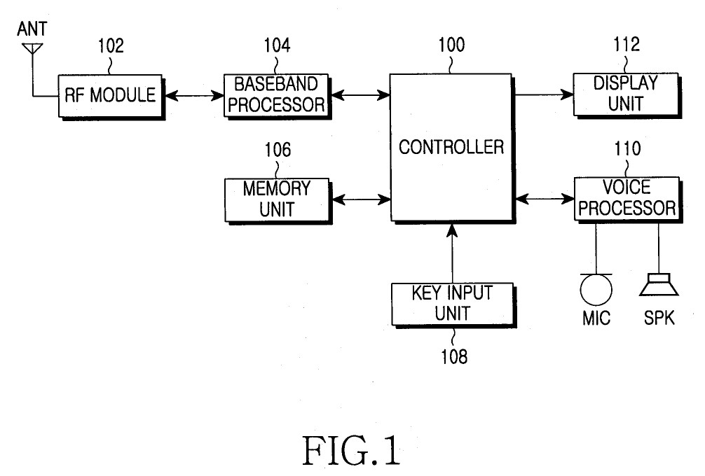

A block diagram of a terminal to which an embodiment of the present invention is applied, wherein the terminal includes an SMS function, will be described with reference to FIG. 1.

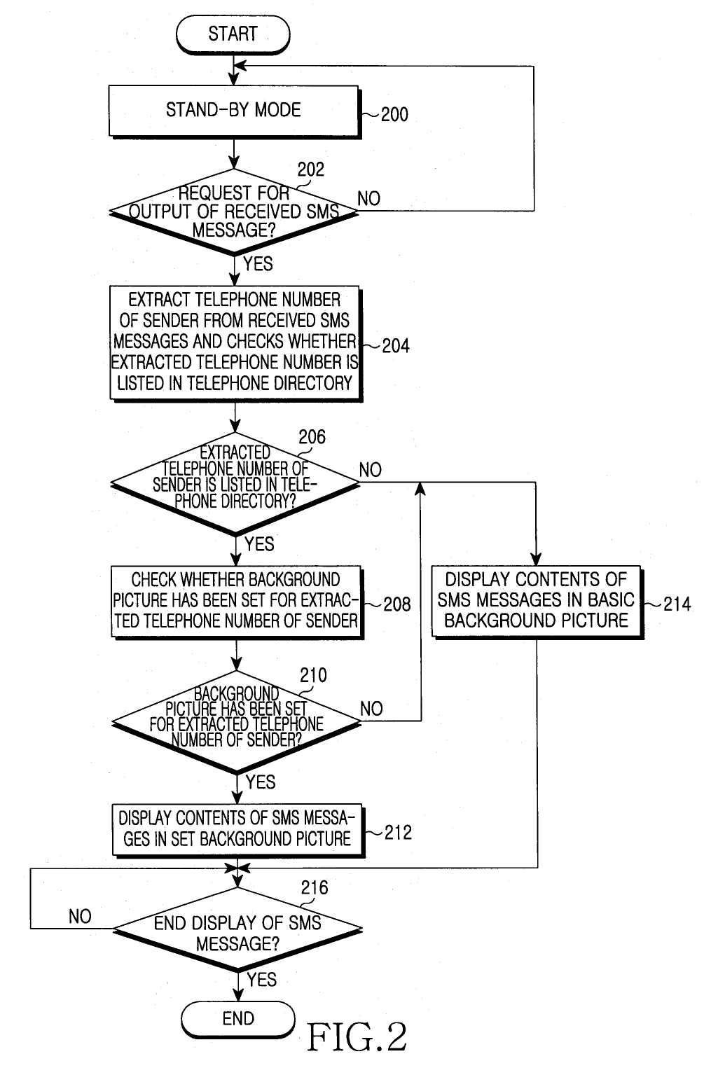

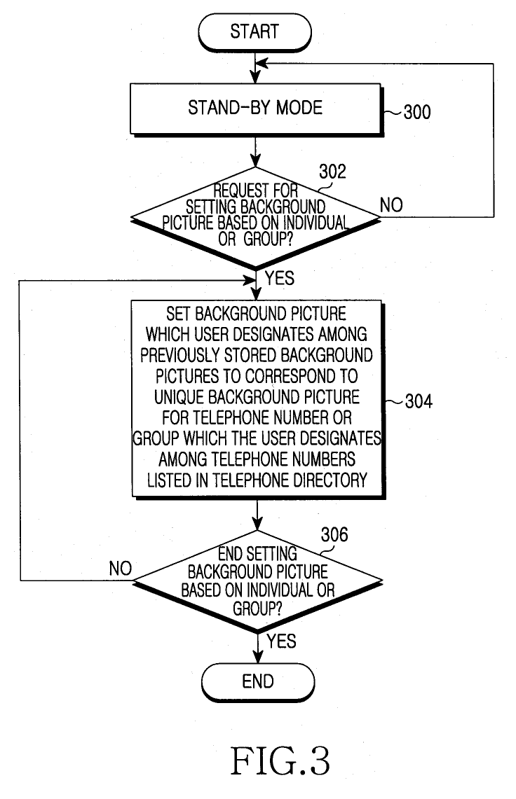

A controller 100 processes and controls normal functions of a phone call, such as data communication. Particularly, when a received SMS message is requested to be output, the controller 100 of the present invention extracts a telephone number of a sender of the SMS message from the received SMS message and checks whether the telephone number is listed in a telephone directory. If the extracted telephone number of the sender is listed in the telephone directory, the controller 100 checks whether a background picture has been set for the extracted telephone number of the sender. If a background picture has been set for the extracted telephone number of the sender, the controller 100 displays contents of the SMS messages in the set background picture through a display unit 112. When a background picture based on an individual or a group is requested to be set, the controller 100 sets a background picture which a user designates among background pictures stored in a memory unit 106 to correspond to a unique background picture for either a telephone number which the user designates among telephone numbers listed in the telephone directory or a group which the user has designated. Detailed operations of the controller 100 are described below with the reference to FIGS. 2 and 3.

A Radio Frequency (RF) module 102 transmits and receives wireless signals with a wireless communication base station through an antenna, modulates signals to be transmitted, which is input from the controller 100 through a baseband processor 104, transmits the RF signals through antenna, demodulates the RF signals received through an antenna, and provides the controller 100 with the demodulated RF signals through the baseband processor 104. The baseband processor 104 processes a baseband signal transmitted and received between the RF module and the controller 100.

Memory unit 106 stores various updatable data such as programs for processing and controlling of the terminal, reference data, and information about telephone numbers, and provides a working memory for the controller 100. The memory unit 106 also stores a telephone directory, which includes a plurality of telephone numbers and a large number of background pictures. Especially, the memory unit 106 according to the present invention causes a unique background picture to correspond to a specified telephone number according to a user's designation, wherein the specified telephone number is set by a background picture setting request individually selected by the user, and stores the background picture. In addition, the memory unit 106 according to the present invention causes a unique background picture to correspond to a group of telephone numbers according to a user's designation, wherein the group of telephone numbers are set with a background picture setting request based on a group set from the user, and stores the background picture.

A key input unit 108 includes number keys (0 to 9), a “*” key, a “#” key and a plurality of function keys such as a menu, a selection, a call, a deletion, power-on/off, a volume control and the like, which correspond to various functions that a corresponding mobile communication terminal includes, and provides the controller 100 with key input data corresponding to a key pressed by a user.

A voice processor 110 processes voice signals for a phone call, a voice record, a voice output and so forth, as input/output of the mobile communication terminal.

A display unit 112 displays various image information and contents of the SMS message, which has been received or stored in the memory unit 106, on the under the control of the controller 100.

Referring to FIG. 2, a description is provided of a request to output a received SMS message and of display of the contents of the SMS messages in the background picture set based on an individual or a group.

The controller 100 maintains a stand-by mode at step 200. Thereafter, the controller 100 proceeds to step 202, and checks whether the received SMS messages are requested to be output. In this case, when SMS messages are requested to be output, there is an immediate request for identifying the received SMS messages or identifying the SMS messages stored in the memory unit 106.

If the received SMS messages are requested to be output as determined in step 202, the controller 100 proceeds to step 204, extracts the telephone number of the sender from the received SMS messages and checks whether the extracted telephone number is listed in the telephone directory. However, if output of the received SMS messages is not requested as determined at step 202, the controller 100 returns to step 200 and maintains a stand-by mode.

If the telephone number of the sender extracted from the received SMS messages is found to be listed in the telephone directory as a result of checking at step 206, the controller 100 proceeds to step 208 and checks whether a background picture has been set for the extracted telephone number of the sender. However, if the telephone number of the sender extracted from the received SMS messages is not found to be listed in the telephone directory at step 204, the controller proceeds to step 214 and displays the contents of the SMS messages in a basic background picture. The basic background picture refers to a background picture which has been set by default when a terminal is manufactured or a background picture applied to all SMS messages displayed by a user.

The controller 100 otherwise proceeds to step 208 and checks if a background picture has been set for the extracted telephone number of the sender. At step 210, the controller 100 checks whether a background picture has been set and proceeds to step 212 to display the contents of the SMS messages in the set background picture, as illustrated in FIG. 5. However, if a background picture is determined not to have been set for the extracted telephone number of the sender at step 210, the controller 100 proceeds to step 214 and displays the contents of the SMS messages in the basic background picture. Herein, a procedure of setting a background picture corresponding to a telephone number of the sender is described in detail with reference to FIG. 3.

Thereafter, the controller 100 proceeds from step 212 to step 216. The controller 100 checks whether there exists an input for ending the display of the SMS messages. If such input exists, the controller 100 ends the display of the SMS message.

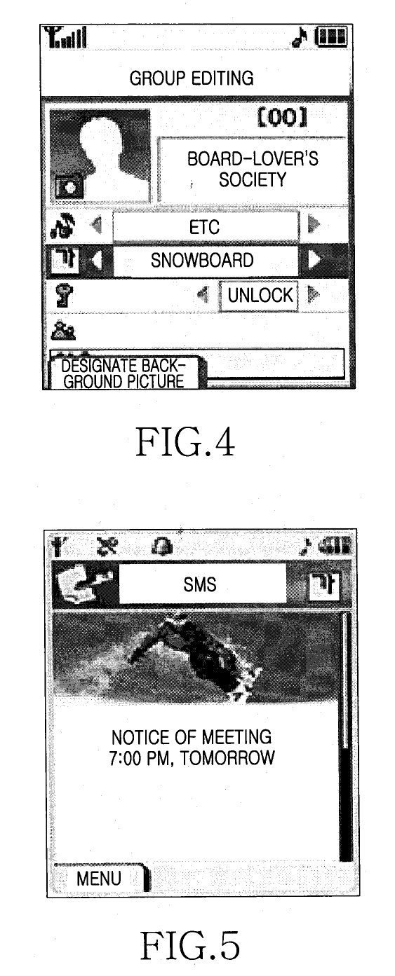

A procedure of setting a background picture based on an individual or a group according to an embodiment of the present invention is now described with reference to FIG. 3. The controller 100 maintains a stand-by mode at step 300, and then proceeds to step 302 to check whether a background picture based on an individual or a group is requested to be set. If requested as a result of checking, the controller 100 proceeds to step 304 and sets a background picture which a user designates from among background pictures previously stored in the memory unit 106 to correspond to a unique background picture for a telephone number or a group which the user designates from among telephone numbers listed in the telephone directory. In this case, the user sets a background picture which the user designates from among background pictures previously stored in the memory unit 106 to correspond to a unique background picture for a telephone number or a group which the user designates from among telephone numbers listed in the telephone directory by using an edit window as illustrated in FIG. 4. If in step 302 it is determined that a background picture setting request was not made, the controller 100 returns to step 300 and maintains the stand-by mode.

After step 304 the controller 100 proceeds to step 306. The controller 100 checks whether there exists an input to end setting a background picture based on an individual or a group. If there exists an input to end setting a background picture based on an individual or a group as a result of checking at step 306, the controller 100 ends setting a background picture based on an individual or a group. If input is not received to end setting a background picture based on an individual or a group at step 306, the controller 100 returns to step 304 and continues to perform operations of setting a background picture based on an individual or a group.

According to the present invention as described above, when received SMS messages, are requested to be output, the contents of the SMS messages are displayed in the background picture uniquely designated to the sender's telephone number of the received SMS messages.

As described above, the present invention has an advantage in that it allows application of various background pictures to SMS messages by displaying the contents of the SMS messages in the background picture which a user has designated according to a sender of the SMS message instead of displaying the contents of the SMS messages in one designated background picture, i.e., displaying all SMS messages in a uniform background picture. Additionally, the present invention has another advantage in that it is possible to easily and sufficiently recognize senders of SMS messages while viewing only background pictures displayed with the contents of the SMS messages

While the invention has been shown and described with reference to certain exemplary embodiments thereof, it will be understood by those skilled in the art that various changes in form and details may be made therein without departing from the spirit and scope of the invention, as defined by the appended claims.

What is claimed is:

1. A terminal for displaying a background picture of SMS messages, the terminal comprising:
a key input unit for outputting a key input data corresponding to an input key;
a memory unit for storing at least one telephone number and at least one background picture, and storing the background picture corresponding to the telephone number;
a display unit for displaying input data; and
a controller for extracting a telephone number of a sender of the SMS message from the SMS message when SMS message is requested to be output, and displaying the contents of the SMS messages in unique background picture corresponding to telephone number of the sender if the background picture corresponding to the extracted telephone number of the sender is stored in the memory unit.

2. The terminal as claimed in claim 1, wherein the controller displays the contents of the SMS messages in a previously stored basic background picture if the background picture corresponding to the extracted telephone number of the sender from the output requested message is not stored in the memory unit according to a request for outputting the message.

3. The terminal as claimed in claim 1, wherein the controller stores a selected or input telephone number in a selected background picture in the memory unit if a telephone number is selected or input among telephone numbers stored in the memory unit, and a background picture is selected among background pictures in order to set a background picture based on an individual.

4. The terminal as claimed in claim 1, wherein the controller stores a plurality of the selected or input telephone number in a selected background picture in the memory unit if a plurality of telephone number are selected or input among telephone numbers stored in the memory unit, and are selected among background pictures in order to set a background picture based on a group.

5. A method for displaying a message background picture with a message in a case when outputting a received message or a stored message in the terminal including an SMS function, the method comprising the steps of:
extracting a telephone number of a sender of the SMS message from the output requested SMS message when the received message or stored message is requested to be output;
checking whether a unique background picture has been set to correspond to the extracted telephone number of the sender; and
displaying the contents of the output requested messages in the set background picture if a unique background picture has been set to correspond to the extracted telephone number of the sender.

6. The method as claimed in claim 5, further comprising a step of displaying the contents of the SMS messages in a previously stored basic background picture if the background picture corresponding to the extracted telephone number of the sender from the output requested message is not stored in the memory unit according to a request for outputting the message

7. The method as claimed in claim 5, further comprising a step of displaying stores the selected or input telephone number in the selected background picture in the memory unit if a telephone number is selected or input among telephone numbers stored in the memory unit, and a background picture is selected among background pictures in order to set a background picture based on an individual.

8. The method as claimed in claim 5, further comprising a step of displaying stores a plurality of the selected or input telephone number in the selected background picture in the memory unit if a plurality of telephone number is selected or input among telephone numbers stored in the memory unit, and a background picture is selected among background pictures in order to set a background picture based on a group.
